(19) United States
(12) Patent Application Publication
(10) Pub. No.: US 2012/0081200 A1
(43) Pub. Date: Apr. 5, 2012

(54) Inductive Device

(76) Inventor: Arturo Silva, Allen, TX (US)

(21) Appl. No.: 13/310,689

(22) Filed: Dec. 2, 2011

(30) Foreign Application Priority Data
Nov. 30, 2011 (GB) 1120606.7

(51) Int. Cl. H01F 21/02; H01F 27/00; H01F 27/29; H01F 27/24; H01F 27/28

(52) U.S. Cl. 336/20; 336/178; 336/221; 336/192; 336/105

(57) ABSTRACT

We describe an inductive device for use in current shaping applications. The inductive device includes a core body comprising a first gap and a second gap, and at least one transition region between the first and second gaps. The shape of each gap in the inductive device can control a slope between two inductance values as a function of load current. The inductive device is capable of providing low total harmonic distortion (THD) AC output waveforms to achieve high efficiency.

### FIELD OF THE INVENTION

The present invention relates to an inductive device for use in current shaping applications. Particularly, but not exclusively, the invention relates to an inductive device for use in a photovoltaic power conditioning unit and a method of controlling distortion in a current and/or voltage waveform in such a power conditioning unit.

### BACKGROUND TO THE INVENTION

We have previously described a range of improved techniques for increasing efficiency in photovoltaic power conditioning units, for example in WO2007/080429 and in many other of our published patent applications.

We now describe improved inductive devices for use in current shaping applications and which are particularly suitable for use in power conditioning units such as those mentioned above. It is known that inductors are commonly used in such power conditioning units. Traditionally, these inductors are designed to prevent magnetic saturation of a core of the inductor. An air gap is generally formed in the core of the inductor such that when the inductor is operated, magnetic flux leaks through the gap and couples with a coil located near the gap. The leaking magnetic flux causes an eddy current in the coil which heats the coil and can cause interference in other components of the power conditioning units. The temperature rise arising from winding loss and core loss therefore has an adverse effect on the power conditioning units. Conventional circuits, e.g. continuous conduction mode (CCM) power factor correction (PFC) circuits, are generally unable to address the problems associated with the winding and core losses.

### SUMMARY OF THE INVENTION

According to a first aspect of the present invention there is provided an inductive device for use in current shaping applications. The device comprises a core body comprising a first gap and a second gap, and at least one transition region between the first and second gaps.

This arrangement can provide a choke inductor structure for use in current shaping applications such as might be required in power factor correction (PFC) circuits. It will be noted that the shape of each gap in the inductor controls a slope between two inductance values as a function of load current. In other words, the nature of the gaps determines the saturation points of the core. It has been found that this arrangement can therefore provide low total harmonic distortion (THD) AC output waveforms to achieve high efficiency.

The first and/or second gap may have one of the following shapes in cross-section:
a substantially symmetrical “V” or “U” shape;
an asymmetrical “V” or “U” shape;
a shape comprising parallel boundaries; or
a shape comprising asymmetrical boundaries.

The core body may further comprise a third gap, and a further transition region between the second and third gaps. The (or each) transition region may be substantially tapered. The cross-sectional area of each gap may be the same but the volume of each gap may be different.

The transition region may be defined as a region where two discrete air gaps meet (i.e. at an interface or boundary between two adjacent discrete gaps). Alternatively, the transition region may form a link between two spaced apart discrete air gaps. In this latter case, the slope of the transition region may itself control a slope between two inductance values as a function of load current. The inductance slope results in a high inductance value close to a zero crossing point in an AC current waveform, which is generally desirable for power factor correction and harmonic distortion applications. The width of the first gap may be the same as or different to the width of the second gap. The transition region may be tapered from the width of the first gap to the width of the second gap.

The inductive device may further comprise a winding on the core body. The winding may comprise at least one flat wire coil which is wound on edge around the core body. The flat wire coil may comprise a flat wire air coil.

The flat wire coil may comprise a relatively large surface area compared to a thickness of the flat wire coil. The flat wire coil may have a thickness equal to or less than a skin depth of the flat wire coil. These configurations result in a reduction in direct current resistance (DCR) copper loss and skin effect loss.

The flat wire coil may be wound in a single layer on the core body to reduce AC proximity winding loss.

At least one of the first and second gaps may extend in a direction transverse to a longitudinal axis of the core body. A separate flat wire coil may be disposed on either side of the first and second gaps. Each flat wire coil may be spaced from the first and second gaps. Each flat wire coil may be connected to a printed circuit board. These arrangements ensure that the interference of longitudinal fringing field with adjacent circuitry is reduced.

The core body may further comprise a back wall and at least one side leg. The back wall and the at least one side leg may each have a relatively large height and width and a relatively small thickness so as to optimise a surface area to volume ratio of the core body.

The inductive device may be configured as a buck inductor, a boost inductor, or a buck-boost inductor.

A power conditioning unit (e.g. for a photovoltaic module) may incorporate the inductive device according to the first aspect of the present invention.

According to a second aspect of the present invention, there is provided a method of controlling distortion in a current and/or voltage waveform in a power conditioning unit (e.g. for a photovoltaic module), the method comprising controlling the shape of an inductive device so as to perform current shaping by the power conditioning unit.

The step of controlling the shape of the inductive device may comprise providing a first gap and a second gap in a core body of the inductive device, and providing at least one transition region between the first and second gaps such that a slope between inductance values as a function of load current is controlled by each gap and/or the or each transition region.

According to a third aspect of the present invention, there is provided a method of manufacturing an inductive device for use in current shaping applications. The method comprises forming a core body of the inductive device, forming a first gap and a second gap in the core body, and forming at least one transition region between the first and second gaps such that a slope between inductance values as a function of load current is controlled by each gap and/or the or each transition region.

### BRIEF DESCRIPTION OF THE DRAWINGS

These and other aspects of the invention will now be further described, by way of example only, with reference to the accompanying figures in which:

FIG. 1 shows an outline block diagram of an example power conditioning unit;

FIGS. 2a and 2b show details of a power conditioning unit of the type shown in FIG. 1;

FIGS. 3a and 3b show details of a further example of solar photovoltaic inverter in which an input power converter incorporates an LLC resonant power converter;

FIG. 4a is a side view of a portion of an inductor for use in the current shaping applications;

FIG. 4b is a partial side view of an alternative inductor;

FIG. 4c is a cross-sectional view of a gap configuration in a core body of an alternative inductor;

FIG. 4d is a cross-sectional view of a gap configuration in a core body of an alternative inductor;

FIG. 4e is a cross-sectional view of a gap configuration in a core body of an alternative inductor;

FIG. 4f is a cross-sectional view of a core body of an alternative inductor;

FIG. 4g is a schematic illustration of inductance performance as a function of load current;

FIG. 5a and FIG. 5b are simulation results for the variation of the inductance as a function of the load current for different types of gaps in the core body of the inductors;

FIG. 6a is an exemplary side view of a flat wire air coil;

FIG. 6b is an exemplary side view of the flat wire coil of FIG. 3a, which is halved along its longitudinal direction;

FIG. 7a is an exemplary cross-section of an alternative inductor;

FIG. 7b is an exemplary plan view of an inductor assembly; and

FIG. 7c is an exemplary plan view of one of the halves of the inductor assembly of FIG. 7b.

### DETAILED DESCRIPTION OF PREFERRED EMBODIMENTS

### Power Conditioning Units

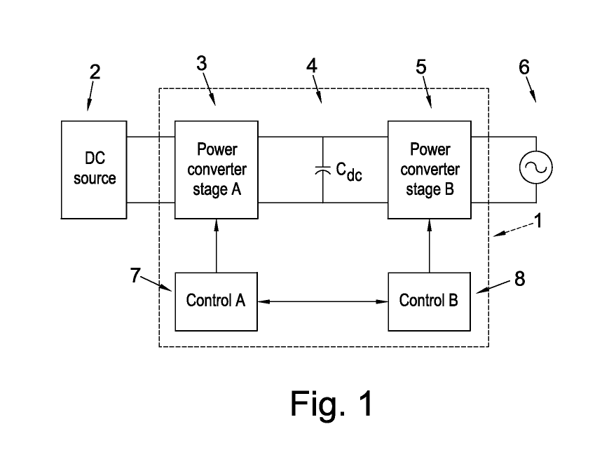

By way of background, we first describe an example photovoltaic power conditioning unit. Thus FIG. 1 shows photovoltaic power conditioning unit of the type we described in WO2007/080429. The power converter 1 is made of three major elements: a power converter stage A, 3, a reservoir (dc link) capacitor C_{dc} 4, and a power converter stage B, 5. The apparatus has an input connected to a direct current (dc) power source 2, such as a solar or photovoltaic panel array (which may comprise one or more dc sources connected in series and/or in parallel). The apparatus also has an output to the grid main electricity supply 6 so that the energy extracted from the dc source is transferred into the supply. Capacitor C_{dc} is preferably non-electrolytic, for example a film capacitor.

The power converter stage A may be, for example, a step-down converter, a step-up converter, or it may both amplify and attenuate the input voltage. In addition, it generally provides electrical isolation by means of a transformer or a coupled inductor. In general the electrical conditioning of the input voltage should be such that the voltage across the dc link capacitor C_{dc} is always higher than the grid voltage. In general this block contains one or more transistors, inductors, and capacitors. The transistor(s) may be driven by a pulse width modulation (PWM) generator. The PWM signal(s) have variable duty cycle, that is, the ON time is variable with respect to the period of the signal. This variation of the duty cycle effectively controls the amount of power transferred across the power converter stage A.

The power converter stage B injects current into the electricity supply and the topology of this stage generally utilises some means to control the current flowing from the capacitor C_{dc} into the mains. The circuit topology may be either a voltage source inverter or a current source inverter.

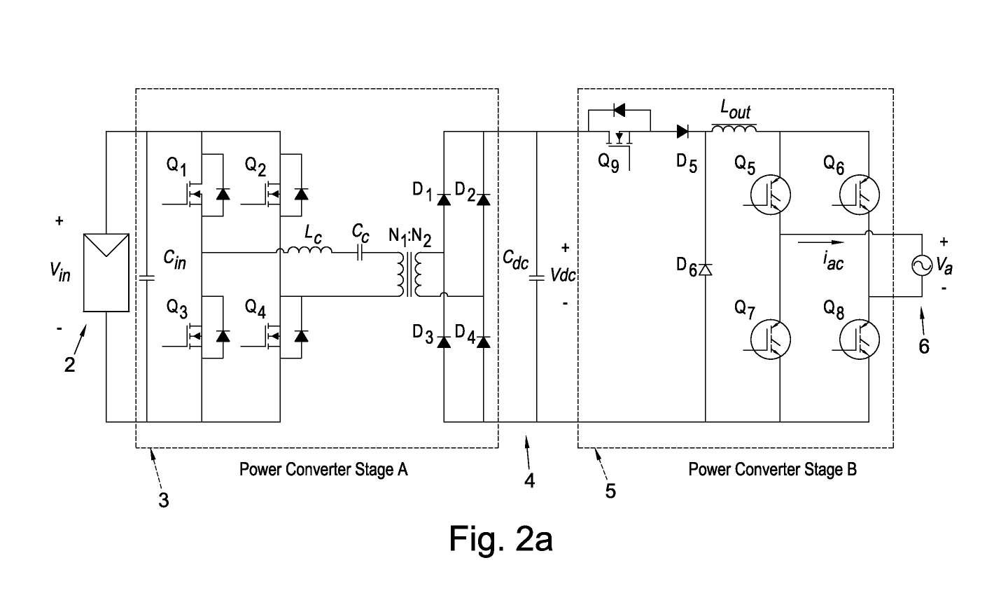

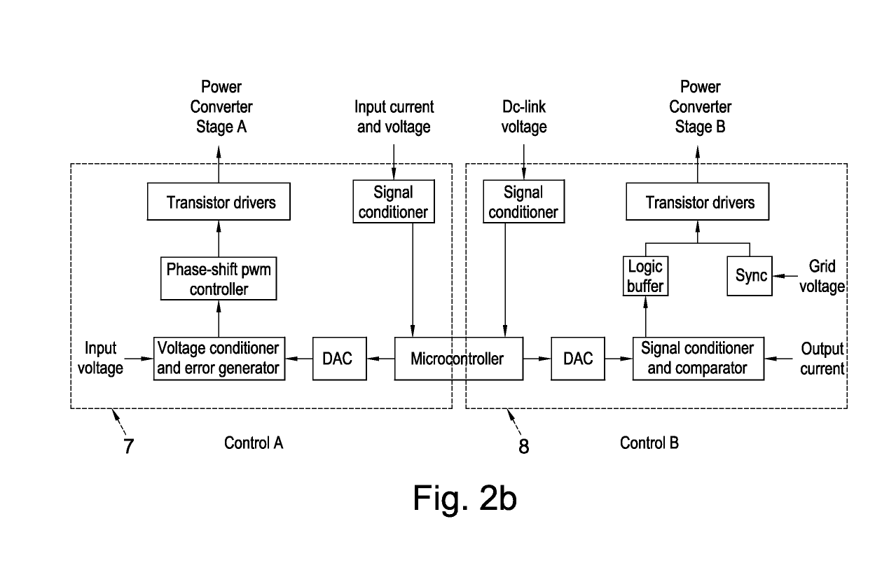

FIG. 2 shows details of an example of a power conditioning unit of the type shown in FIG. 1; like elements are indicated by like reference numerals. In FIG. 2a Q1-Q4, D1-D4 and the transformer form a dc-to-dc conversion stage, here a voltage amplifier. In alternative arrangements only two transistors may be used; and/or a centre-tapped transformer with two back-to-back diodes may be used as the bridge circuit.

In the dc-to-ac converter stage, Q9, D5, D6 and Lout perform current shaping. In alternative arrangements this function may be located in a connection between the bridge circuit and the dc link capacitor: D₆ acts as a free-wheeling diode and D₅ prevents current form flowing back into the dc-link. When transistor Q₉ is switched on, a current builds up through Lₒᵤₜ. When Q₉ is switched off, this current cannot return to zero immediately so D₆ provides an alternative path for current to flow from the negative supply rail (D₅ prevents a current flowing back into the dc-link via the body diode in Q₉ when Q₉ is switched off). Current injection into the grid is controlled using Q₉: when Q₉ is turned on the current flowing through Lₒᵤₜ increases and decreases when it is turned off (as long as the dc-link voltage is maintained higher than the grid voltage magnitude). Hence the current is forced to follow a rectified sinusoid which is in turn unfolded by the full-bridge output (transistors Q₅ to Q₈). Information from an output current sensor is used to feedback the instantaneous current value to a control circuit: The inductor current, iₒᵤₜ, is compared to a reference current, i_{ref}, to determine whether or not to switch on transistor Q₉. If the reference current is higher than iₒᵤₜ then the transistor is turned on; it is switched off otherwise. The reference current, i_{ref}, may be generated from a rectified sinusoidal template in synchronism with the ac mains (grid) voltage.

Transistors Q5-Q8 constitutes an “unfolding” stage. Thus these transistors Q5-Q8 form a full-bridge that switches at line frequency using an analogue circuit synchronised with the grid voltage. Transistors Q5 and Q8 are on during the positive half cycle of the grid voltage and Q6 and Q7 are on during the negative half cycle of the grid voltage.

Control (block) A of FIG. 1 may be connected to the control connections (e.g. gates or bases) of transistors in power converter stage A to control the transfer of power from the dc energy source. The input of this stage is connected to the dc energy source and the output of this stage is connected to the dc link capacitor. This capacitor stores energy from the dc energy source for delivery to the mains supply. Control (block) A may be configured to draw such that the unit draws substantially constant power from the dc energy source regardless of the dc link voltage V_{dc} on C_{dc}.

Control (block) B may be connected to the control connections of transistors in the power converter stage B to control the transfer of power to the mains supply. The input of this stage is connected to the dc link capacitor and the output of this stage is connected to the mains supply. Control B may be configured to inject a substantially sinusoidal current into the mains supply regardless of the dc link voltage V_{dc} on C_{dc}.

The capacitor C_{dc} acts as an energy buffer from the input to the output. Energy is supplied into the capacitor via the power stage A at the same time that energy is extracted from the capacitor via the power stage B. The system provides a control method that balances the average energy transfer and allows a voltage fluctuation, resulting from the injection of ac power into the mains, superimposed onto the average dc voltage of the capacitor C_{dc}. The frequency of the oscillation can be either 100 Hz or 120 Hz depending on the line voltage frequency (50 Hz or 60 Hz respectively).

Two control blocks control the system: control block A controls the power stage A, and control block B power stage B. An example implementation of control blocks A and B is shown in FIG. 2b. In this example these blocks operate independently but share a common microcontroller for simplicity.

In broad terms, control block A senses the dc input voltage (and/or current) and provides a PWM waveform to control the transistors of power stage A to control the power transferred across this power stage. Control block B senses the output current (and voltage) and controls the transistors of power stage B to control the power transferred to the mains. Many different control strategies are possible.

In a photovoltaic power conditioning unit the microcontroller of FIG. 2b will generally implement an algorithm for some form of maximum power point tracking.

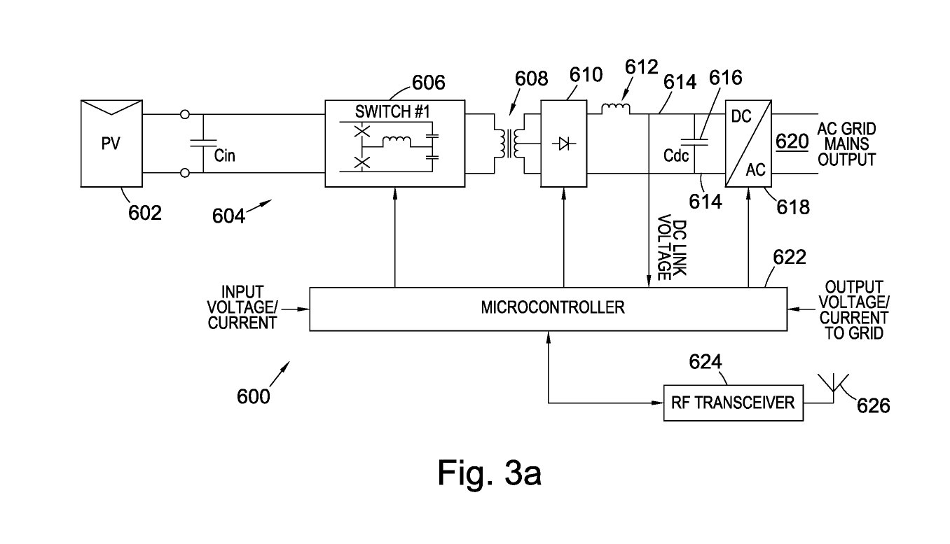

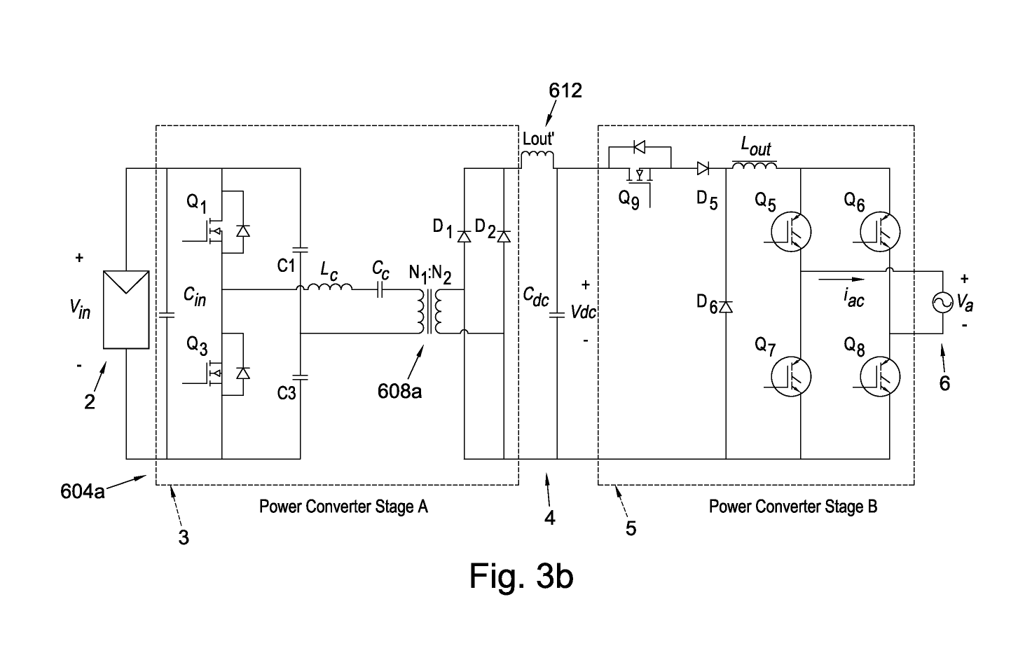

Now to FIG. 3a, this shows a further example of a power conditioning unit 600. In the architecture of FIG. 3 a photovoltaic module 602 provides a dc power source for dc-to-dc power conversion stage 604, in this example each comprising an LLC resonant converter. Thus power conversion stage 604 comprises a dc-to-ac (switching) converter stage 606 to convert dc from module 602 to ac for a transformer 608. The secondary side of transformer 608 is coupled to a rectifying circuit 610, which in turn provides a dc output to a series-coupled output inductor 612. Output inductor 612 is coupled to a dc link 614 of the power conditioning unit, to which is also coupled a dc link capacitor 616. A dc-to-ac converter 618 has a dc input from a dc link and provides an ac output 620, for example to an ac grid mains supply.

A microcontroller 622 provides switching control signals to dc-to-ac converter 606, to rectifying circuit 610 (for synchronous rectifiers), and to dc-to-ac converter 618 in the output ‘unfolding’ stage. As illustrated microcontroller 622 also senses the output voltage/current to the grid, the input voltage/current from the PV module 602, and, in embodiments, the dc link voltage. (The skilled person will be aware of many ways in which such sensing may be performed). In some embodiments the microcontroller 622 implements a control strategy as previously described. As illustrated, Microcontroller is coupled to an RF transceiver 624 such as a ZigBee™ transceiver, which is provided with an antenna 626 for monitoring and control of the power conditioning unit 600.

Referring now to FIG. 3b, this shows details of a portion of an example implementation of the arrangement of FIG. 3a. This example arrangement employs a modification of the circuit of FIG. 2a and like elements to those of FIG. 2a are indicated by like reference numerals; likewise like elements to those of FIG. 3a are indicated by like reference numerals. In the arrangement of FIG. 3b an LLC converter is employed (by contrast with FIG. 2a), using a pair of resonant capacitors C1, C3.

The circuits of FIGS. 1 to 3 are particularly useful for microinverters, for example having a maximum rate of power of less than 1000 Watts and or connected to a small number of PV modules, for example just one or two such modules. In such systems the panel voltages can be as low as 20 volts and hence the conversion currents can be in excess of 30 amps RMS.

### Inductive Devices for Use in a Power Conditioning Unit

We will now describe various embodiments of improved inductive devices for use, for example, in the power conditioning units described hereinbefore. It will be appreciated that the inductive devices can also be used in other power conditioning units which are not described above.

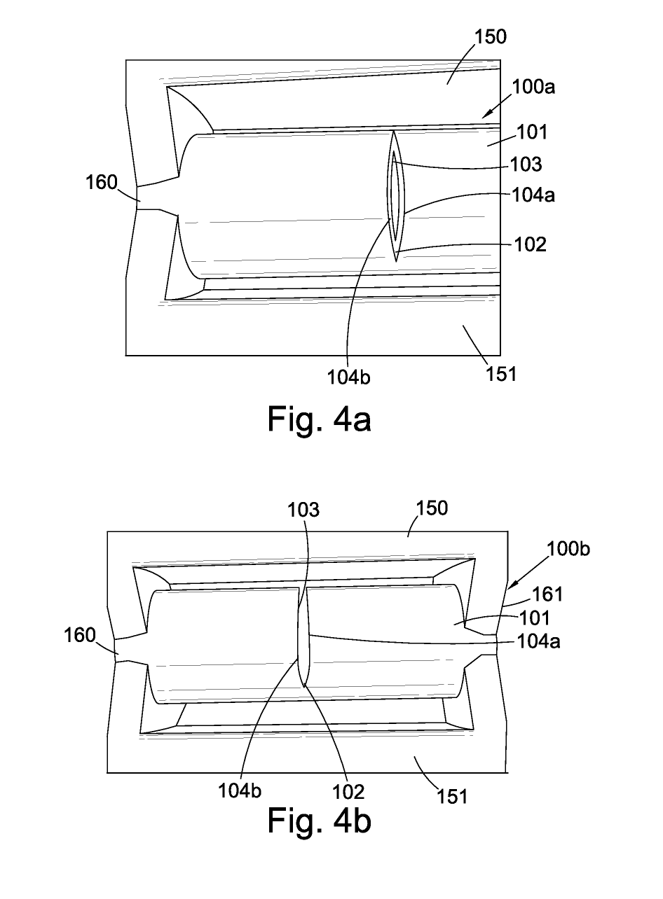

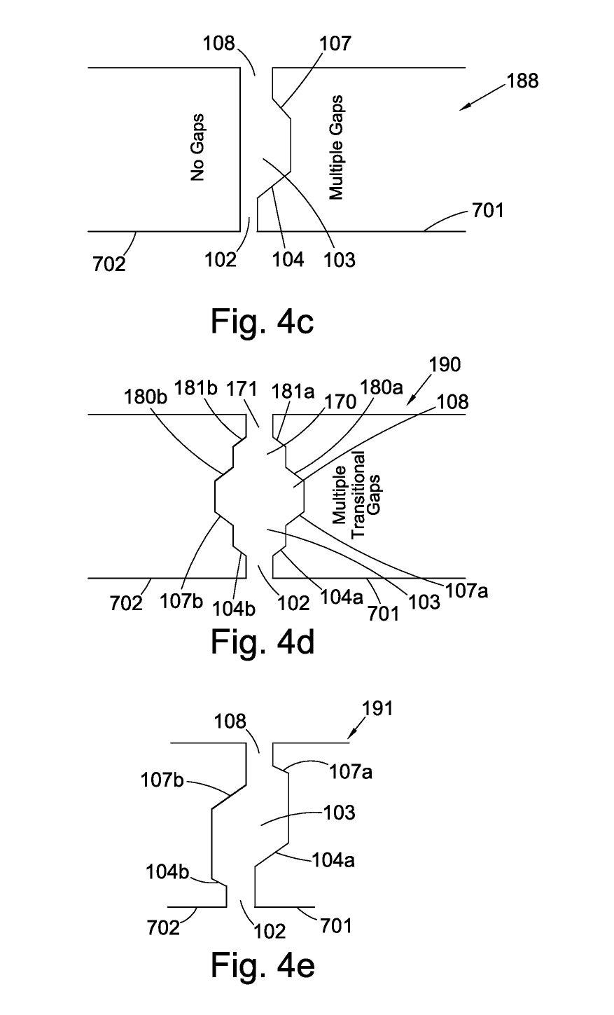

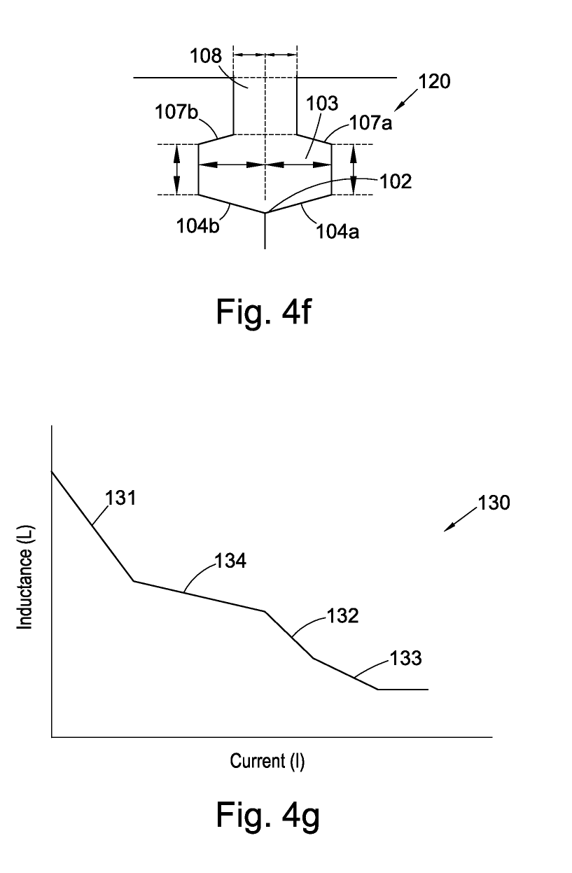

FIG. 4a is a side view of a portion of an inductor 100a for use in current shaping applications. The inductor includes a substantially cylindrical core body 101 which is shaped at its centre to include a first gap 102 and an opposite second gap 103. The first and second gaps are substantially “V” shaped and are radially orientated such that they each open out towards the centre of the core body 101 and are closed towards the top and bottom edges of the core body 101. The first and second gaps 102, 103 are spaced apart such that there is a transition region 104a, 104b between the first and second gaps 102, 103. The first and second gaps 102, 103 are adjoined by the transition region 104a, 104b which is formed between two substantially parallel wall portions 104a, 104b. The core body 101 generally includes two side legs 150, 151 and two back walls 160 (a second back wall is not shown in the portion of the inductor of FIG. 4a).

FIG. 4b is a side view of an alternative inductor 100b. Many features are the same as the inductor of FIG. 4a, carrying the same reference numerals. However, FIG. 4b shows a second back wall 161 of the core body 101 and the shapes of the first and second gaps 102, 103 in FIG. 4b are different. In this embodiment, the first gap 102 is substantially “U” shaped and the second gap 103 comprises two symmetrical boundaries which taper towards each other but do not meet at an outer edge of the core body 101. In this embodiment, the first gap 102 is spaced from a lower edge of the core body 101 such that below the first gap 102, the two sides of the core body 101 abut each other.

It may be possible that the core body is formed in two halves, with one end of each halve of the core body being shaped to form the gaps and the transition region when the two halves are provided adjacent each other, as shown with reference to the arrangements of FIGS. 4a and 4b. It may also possible that one end of one of the halves of the core body is shaped to form the gaps and the transition region, and any ends of the other halve of the core body does not form any gaps and/or transition regions. Such an arrangement is shown in FIG. 4c, which is a cross-sectional view of a gap configuration 188 in a core body of an alternative inductor. A first halve 701 of the core body is shaped such that a first gap 102, a second gap 103 and a third gap 108 are formed. A second halve 702 is not shaped to form any gaps. Such an arrangement produces gaps in the core body having asymmetric boundaries. A first transition region 104 is situated between the first and second gaps 102, 103 and a second transition region 107 is situated between the second and third gaps 103, 108. The width of the first gap 102 is less than the width of the second gap 103. This difference in width results in the first transition region 104 tapering inwardly towards the first gap 102. The width of the third gap 108 is less than the width of the second gap 103 but greater than the width of the first gap 102. Similarly, this difference in width results in the second transition region 107 tapering inwardly towards the third gap 108.

FIG. 4d is a cross-sectional view of a gap configuration 190 in a core body of an alternative inductor. Both halves 701, 702 of the core body are shaped such that the gap configuration 190 includes five gaps 102, 103, 108, 170, 171. Each gap includes radially parallel boundaries. The width of a first gap 102 is less than the width of a second gap 103. This difference in width results in a first transition region 104a, 104b tapering inwardly towards the first gap 102. The width of a third gap 108 is greater than the width of the second gap 103. Similarly, this difference in width results in a second transition region 107a, 107b tapering inwardly towards the second gap 103. Furthermore, the width of the third gap 108 is greater than the width of a fourth gap 170, which results in a third transition region 180a, 180b tapering inwardly towards the fourth gap 170. The width of a fifth gap 171 is less than the width of the fourth gap 170, which results in a fourth transition region 181a, 181b tapering inwardly towards the fifth gap 171. The area of each gap and the slope of each transition region can control the performance of the inductor.

FIG. 4e is a cross-sectional view of a gap configuration 191 in a core body of an alternative inductor. Unlike the arrangement of FIG. 4c, both halves 701, 702 of the core body are shaped such that the gap configuration 191 includes a first gap 102, a second gap 103 and a third gap 108. Each gap has asymmetric boundaries. A first transition region 104a, 104b is situated between the first and second gaps 102, 103 and a second transition region 107a, 107b is situated between the second and third gaps 103, 108. The width of the first gap 102 is less than the width of the second gap 103. This difference in width results in the first transition region 104 tapering inwardly towards the first gap 102. The width of the third gap 108 is less than the width of the second gap 103, which results in the second transition region 107a, 107b tapering inwardly towards the third gap 108.

In FIG. 4e, the length of a tapered portion 104a of the first transition region 104a, 104b, which is situated in a first halve 701 of the core body, is greater than the length of a tapered portion 104b of the first transition region 104a, 104b, which is situated in a second halve 702 of the core body. By contrast, the length of a tapered portion 107a of the second transition region 107a, 107b, which is situated in the first halve 701 of the core body, is less than the length of a tapered portion 107b of the first transition region 104a, 104b, which is situated in the second halve 702 of the core body. As a result, the boundaries and the area of each gap are asymmetric. The length and area of each gap determines the performance and saturation point of the inductor.

FIG. 4f is a cross-sectional view of a gap configuration 120 in a core body of an alternative inductor. The core body is shaped such that the gap configuration 120 includes a first gap 102, a second gap 103 and a third gap 108, each of the gaps having radially parallel boundaries. A first transition region 104a, 104b is situated between the first and second gaps 102, 103 and a second transition region 107a, 107b is situated between the second and third gaps 103, 108. The width of the first gap 102 is less than the width of the second gap 103. This difference in width results in the first transition region 104a, 104b tapering inwardly towards the first gap 102. The width of the third gap 108 is less than the width of the second gap 103 but greater than the width of the first gap 102. Similarly, this difference in width results in the second transition region 107a, 107b tapering inwardly towards the third gap 108.

It will be appreciated that one or both sides of each halve of the core body of the inductor may comprise conical or frusto-conical recessed regions to form the gaps. It may be possible that the transition regions between the gaps are frusto-conical in shape. In certain embodiments, the gaps may vary in one direction (e.g. down the body as shown in FIGS. 4a and 4b) and may be constant in an orthogonal direction (e.g. across the body). However, in other embodiments, the gaps may vary in two directions (e.g. down and across the body), for example, where the body comprises a conical recess with an axis generally parallel to or angled with respect to the longitudinal axis of the body.

The number of gaps, the area of the gaps and the transition regions between the gaps are used to control the inductance verses load performance. Such an inductance performance 130 as a function of load current is illustrated in FIG. 4g. In this embodiment, the steepness of a first inductance slope 131 is controlled by the first gap 102 of the inductor of FIG. 4f. In this example, the first transition region 104a, 104b controls the steepness of a second inductance slope 132 and the second gap 103 controls a third inductance slope 133. A fourth inductance slope 134, between the first slope 131 and the second slope 132, is controlled by the shape of the third gap 108. Although the inductance performance as a function of load current of FIG. 4g is described in view of the inductor arrangement of FIG. 4f, it will be appreciated that it is also possible to control the inductance performance on the basis of the arrangements of FIGS. 4a to 4e.

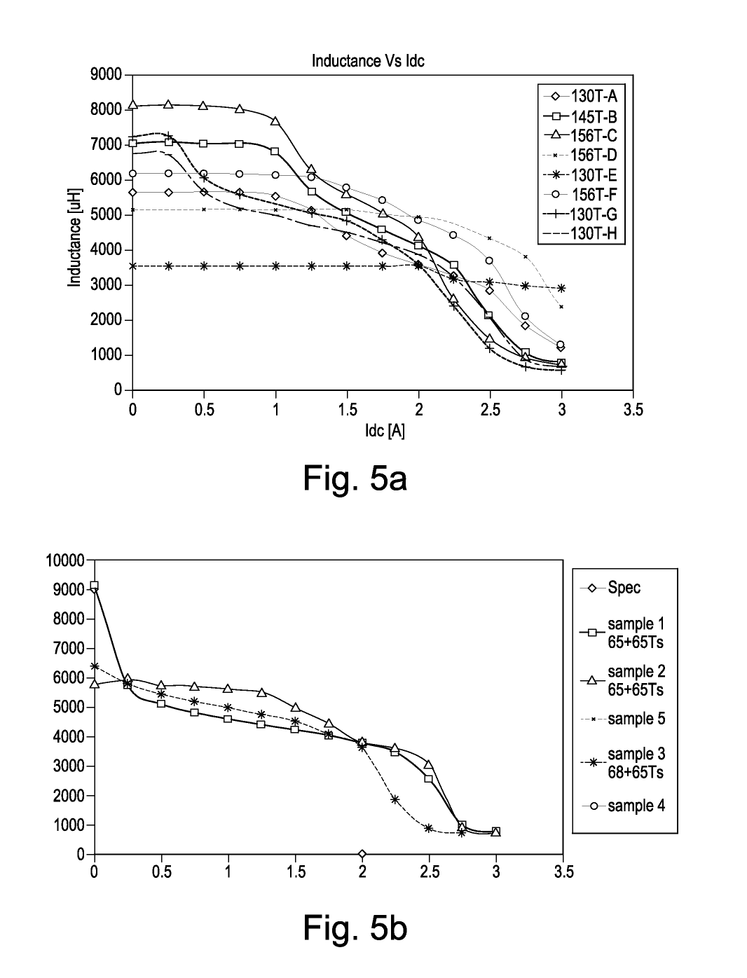

FIG. 5a and FIG. 5b are simulation results for the variation of the inductance as a function of the load current for different types of gaps in core bodies of inductors such as those described above. The slope variations are similar to those explained with reference to FIG. 4d. In these figures, the inductance is varied from a high value to a low value with different slopes which are controlled by the shape of the gaps and the transition regions in each core body. These controllable slopes provide low total harmonic distortion (THD) AC output waveforms which achieve high efficiency. It is noted that a high inductance value helps to smooth the current waveform close to the zero crossing points of the AC current waveform. As a result, the inductance slopes help to achieve sufficiently high inductance when the current is relatively low close to the zero crossing points. This would otherwise be almost impossible to achieve with a similar size and number of turns on the inductor (but without the gap configurations described hereinbefore). It is also noted that the peak current (iₚₖ) of the inductor is VᵢₙXTₒₙ/L. On this basis, when the peak current (iₚₖ) is higher the inductance (L) for a given iₚₖ value (which is needed for the switching frequency) is reduced. Switching losses can therefore be reduced by having higher inductance (for a given duty cycle, Ton) to result in reduced peak current.

Furthermore, it is possible to achieve high surface area to volume ratio of the core body compared to that of the conventional inductors. The core body generally includes two back walls and two side legs as shown in FIG. 4b. Each of the back walls and the side legs has a relatively large height and width and a relatively small thickness so as to increase surface area and decrease volume as much as possible. This produces an optimised surface area to volume ratio of the core body.

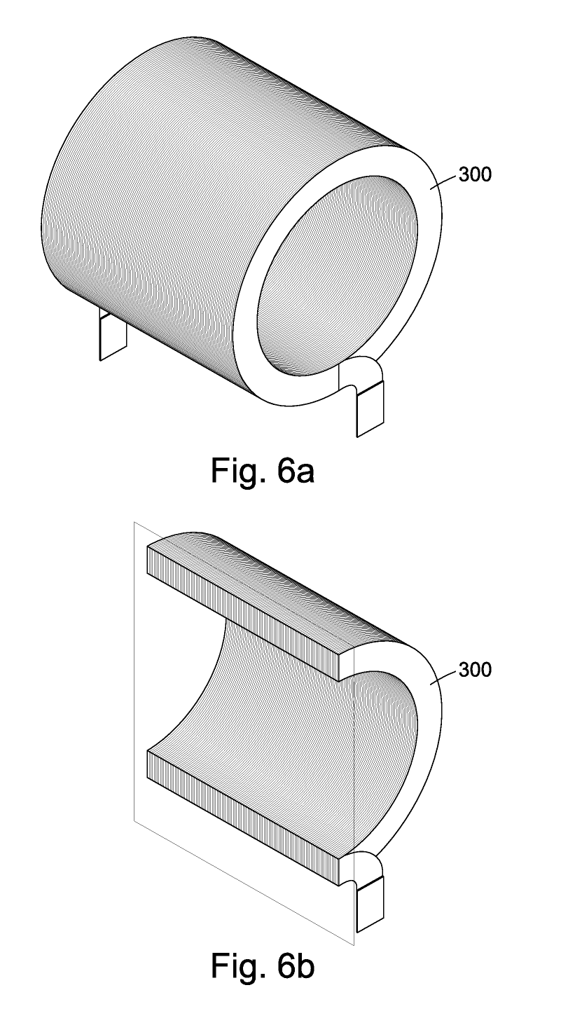

FIG. 6a is a schematic side view of a flat wire air coil 300. The flat wire coil 300 is wound on edge around the core body of the inductor described with reference to FIGS. 4a to 4c. FIG. 6b is also a schematic side view of the flat wire coil 300 of FIG. 6a, which is halved along its longitudinal direction.

In FIGS. 6a and 6b, the flat wire coil 300 has a large longitudinal cross sectional area compared to its thickness, which reduces direct current resistance (R_{DC}) copper loss. At the same time, the cross sectional area also reduces skin effect loss due to high frequency components of a CCM or discontinuous conduction mode (DCM) circuits. The thickness of the flat wire is generally optimised to be equal or smaller to a skin depth. The skin depth is defined as the distance below the surface where the current intensity has reached, for example, about 37% of the current intensity of the surface. Therefore the thickness ensures that the current intensity does not reach below, for example, 37% of the current intensity at the surface. It is noted that the skin effect is accountable when the ratio of the direct current resistance and alternating current resistance (R_{AC}/R_{DC}) is generally more than 1. However, the optimum flat wire thickness can be found when R_{AC}/R_{DC} is generally about 1. For example, at 25 KHz, the skin depth is 0.04186 cm, at 50 KHz, the skin depth is 0.029606 cm, and at 100 KHz, the skin depth is 0.0209 cm (when the surface area of the wire is about 0.6 mm²). On this basis, the flat wire thickness should be less then about twice the skin depth

The single conductor wire diameter is 0.88 mm. For a wire size of American Wire Gauge (AWG) 19.3, the maximum frequency would be about 23 kHz. In one example, low AC winding loss can be achieved by using a wire having a thickness of 0.2 mm and a width of 3 mm. The wire having these dimensions can be wound on edge around the inductor. This will reduce the skin effect due to large surface area and small thickness which is less than the skin depth with a preferable limit of 120 kHz.

Furthermore, the AC proximity winding loss can be optimised by using the flat wire coil as a single layer winding on the inductor.

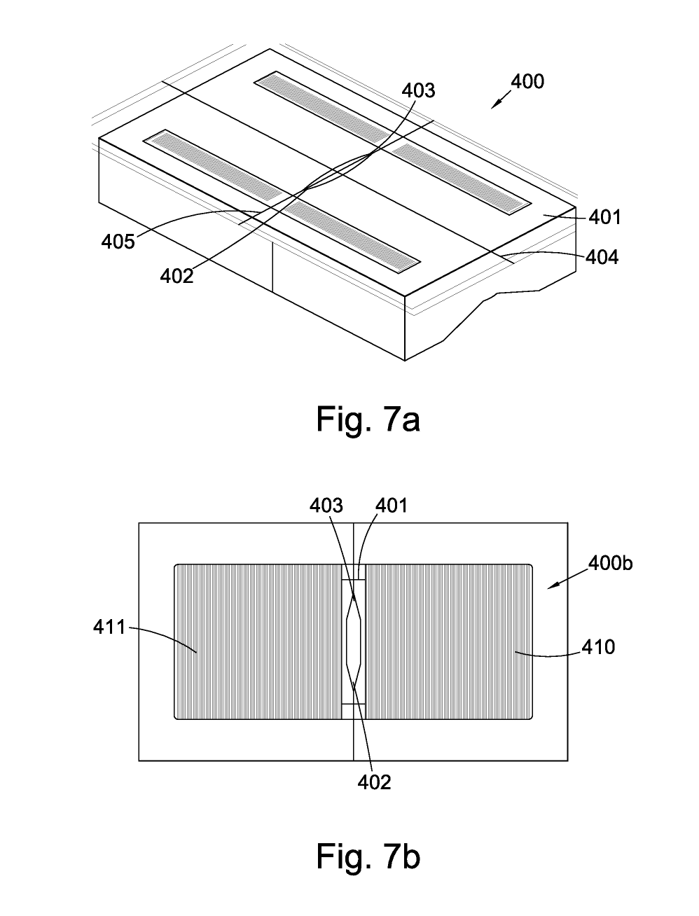

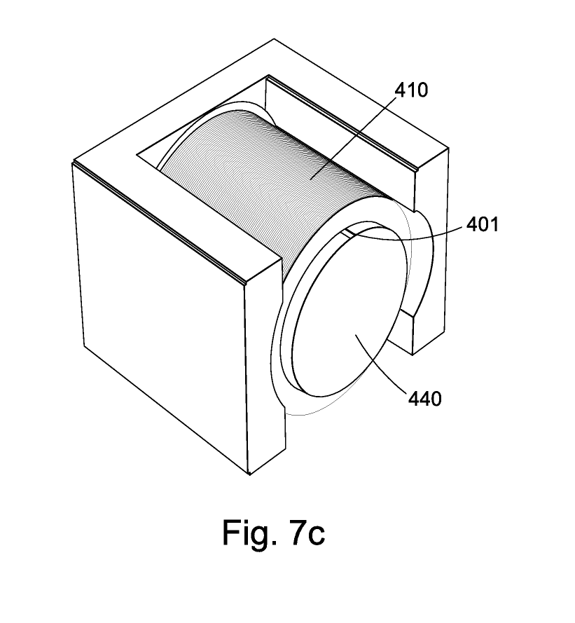

The arrangements of the gaps in the core body and the flat wire coil on the core body can produce a low longitudinal (horizontal) fringing field to reduce interference with neighbouring circuitry. Such an effect is achieved in the arrangements of FIGS. 7a to 7c. FIG. 7a is an exemplary cross-section of an alternative inductor 400a. In this arrangement, a core body 401 includes gaps 402, 403 as described in relation to FIG. 4a. The core body 401 has a longitudinal axis 404 which is substantially perpendicular to a longitudinal axis 405 of the gaps 402, 403. In other words, the gaps 402, 403 are extending transversely to the longitudinal axis 404 of the core body 401. This arrangement reduces high frequency electromagnetic field near the gaps 402, 403 on the longitudinal axis 404 of the core body 401.

Longitudinal fringing field can be further reduced by modifying the arrangement of the winding on the core body of the inductor. Such an arrangement is shown in FIG. 7b which is an exemplary plan view of an inductor assembly 400b. Many features of the core body 401 of the inductor are the same as those of FIG. 7a, carrying the same references. In this arrangement, two separate flat wire coils 410, 411 are provided on both longitudinal sides of the gaps 402, 403. The separate coils 410, 411 are optionally spaced away from the gaps 402, 403. The separate coils 410, 411 can be operably connected to a printed circuit board (PCB). Having no windings over the gaps generally results in the lowest loss.

FIG. 7c is an exemplary plan view of one of the halves of the inductor assembly of FIG. 7b. Many features of the inductor assembly are the same as those of FIG. 7b, carrying the same references. In this embodiment, the core body 401 comprises a face 440 which can be shaped to form the gaps described hereinbefore with reference to the present invention. The flat wire coil 410 is longitudinally spaced away from the face 440 where the gaps can be formed.

Arranging the coil in two separate parts and connecting it with the PCB are particularly advantageous. Such an arrangement significantly reduces the fringing flux known as “gap loss”, which generally increases AC resistance on the winding close to the gaps. Since the separate coils are spaced away from the gaps, the thermal performance of the inductor is improved.

Furthermore, arranging the winding in two separate coils 410, 411 reduces the cost and manufacturability of the coils. Assembling the coils on the core body is relatively simple and it is suitable for high volume production. In one example, the coils can be made using automatic winding machines and assembled manually on the core body after optionally placing insulators and spacers. Alternatively, a structure like a bobbin can be provided on which a litz wire is wound, for example by semi automatic winding machines. The overall conductor area of the litz wire would greater than the flat wire. Alternatively, a toroid core body can be wound completely by hand.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A renewable energy inductive device for use in current shaping applications, the device comprising:
a core body comprising a first gap and a second gap, and at least one transition region between the first and second gaps.

2. The inductive device of claim 1, wherein at least one of the first and second gaps extends in a direction transverse to a longitudinal axis of the core body.

3. The inductive device of claim 1, wherein the first and/or second gap has one of the following shapes in cross-section:
a substantially symmetrical “V” or “U” shape;
an asymmetrical “V” or “U” shape;
a shape comprising parallel boundaries; and
a shape comprising asymmetrical boundaries.

4. The inductive device of claim 1, wherein the core body further comprises a third gap, and a further transition region between the second and third gaps.

5. The inductive device of claim 1, wherein the or each transition region is substantially tapered.

6. The inductive device of claim 4, wherein the dimensions of each gap are substantially different.

7. The inductive device of claim 1, wherein the cross sectional area of each gap is the same but the volume of each gap is different.

8. The inductive device of claim 1, further comprising a winding on the core body.

9. The inductive device of claim 8, wherein the winding comprises at least one flat wire coil which is wound on edge around the core body.

10. The inductive device of claim 9, wherein the at least one flat wire coil comprises a relatively large surface area compared to a thickness of the flat wire coil.

11. The inductive device of claim 9, wherein the at least one flat wire coil has a thickness equal to or less than a skin depth of the flat wire coil.

12. The inductive device of claim 8, wherein the at least one flat wire coil is wound in a single layer on the core body.

13. The inductive device of claim 8, wherein a separate flat wire coil is disposed in either side of the first and second gaps.

14. The inductive device of claim 13, wherein each flat wire coil is spaced from the first and second gaps.

15. The inductive device of claim 13, wherein each flat wire coil is connected to a printed circuit board.

16. The inductive device of claim 1, wherein the core body further comprises a back wall and at least one side leg.

17. The inductive device of claim 16, wherein the back wall and the at least one side leg each has a relatively large height and width and a relatively small thickness so as to optimise a surface area to volume ratio of the core body.

18. The inductive device of claim 1, wherein a photovoltaic power conditioning unit comprises the inductive device, wherein the inductive device is configured as:
a buck inductor;
a boost inductor; or
a buck-boost inductor.

19. A method of controlling distortion in a current and/or voltage waveform by a photovoltaic power conditioning unit, the method comprising:
controlling the shape of an inductive device so as to perform current shaping by the power conditioning unit.

20. The method according to claim 19, wherein the controlling the shape of the inductive device comprises:
providing a first gap and a second gap in a core body of the inductive device; and
providing at least one transition region between the first and second gaps such that a slope between inductance values as a function of load current is controlled by each gap and/or the or each transition region.

21. (canceled)
